(19) United States
(12) Patent Application Publication
(10) Pub. No.: US 2025/0165232 A1
(43) Pub. Date: May 22, 2025

(54) METHOD FOR GENERATING SOURCE CODE

(71) Applicant: dSPACE GmbH, Paderborn (DE)

(72) Inventors: Michael MAIR, Paderborn (DE); Florian GAYK, Paderborn (DE)

(21) Appl. No.: 18/947,041

(22) Filed: Nov. 14, 2024

(30) Foreign Application Priority Data
Nov. 17, 2023 (DE) 102023132111.0

(51) Int. Cl. G06F 8/35; G06F 8/41

(52) U.S. Cl. CPC G06F 8/35; G06F 8/433

(57) ABSTRACT

A method for generating source code includes: transforming, by a computing device, a block diagram into an intermediate representation; successively optimizing, by the computing device, the intermediate representation; and translating, by the computing device, the optimized intermediate representation into source code. Transforming a block comprises creating a reference to a block output variable. Creating the reference to the block output comprises: detecting at least two parallel control flow branches which read or write a variable; identifying an operation that accesses the variable; checking whether a cost criterion is satisfied; and reproducing the operation in the at least two parallel control flow branches based on the cost criterion being satisfied. Reproducing the operation comprises shifting the operation from an original position to positions where the variable is read or written.

### CROSS-REFERENCE TO PRIOR APPLICATIONS

This application claims benefit to German Patent Application No. DE 102023132111.0, filed on Nov. 17, 2023, which is hereby incorporated by reference herein.

### FIELD

The invention relates to generating executable code from a block diagram, in particular for programming control devices.

### BACKGROUND

Control devices are used in many different applications in order to record physical variables of a process and/or influence a process using connected actuators, for example an anti-lock control in a braking operation. The time constants determining the dynamic behavior of the process often require cycle times of 1 ms or less, so the control device must have real-time capabilities. For reasons of cost, control devices often include microcontrollers having a small memory and limited computing power, which is why the size and efficiency of the executable code is very important.

To design control devices more quickly, control strategies are often developed on the basis of models in a computing environment such as MATLAB/Simulink. Therefore, the process and/or the controller, or the behavior of the control device in general, can be simulated first and it can be checked whether desired properties are present. In particular, the models may be block diagrams comprising blocks that execute operations such as calculations; by way of example, a block may calculate one output signal from a plurality of input signals. In general, block diagrams are executed cyclically, with all blocks being permanently retained in the memory and each block being executed once per time step. In particular, in each time step a block may apply one or more operations to input signals from the parent block in order to generate output signals for the current step. Block diagrams may additionally comprise a sub-model for describing a discrete behavior in which a number of states and transition conditions are defined.

Source code for programming the control device can be generated from the models using a code generator. A code generator for generating source code in production quality is described, for example, in the document “Production Quality Code Generation from Simulink Block Diagrams”, Proceedings of the 1999 International Symposium on Computer Aided Control System Design, Kohala Coast, Hawaii, H. Hanselmann et al.

If models are described in the form of a block diagram, with blocks being linked to exchange data or relay signals via directional links or signal links, a normal code generation approach involves generating one variable in the source code for each output of a block. However, the drawback of this is that generally more block variables than are actually needed are initially produced in the process. The number of block variables, or the code size in general, can be reduced by subsequent optimization. For instance, EP 2418577 A1 describes transforming a block diagram into an intermediate representation and applying at least one optimization to said intermediate representation in order to generate an optimized intermediate representation. Many different optimizations known per se from compiler construction can be successively applied in order to generate intermediate representations that are optimized further. Next, C code in particular is generated from the optimized intermediate representation.

Often, conventional optimizations cannot be applied due to prerequisites not being satisfied, potentially resulting in code that has only been optimized to a limited extent. In the case of parallel control flow branches, for example, at the time the code is generated it may be unclear which branch is executed because the conditions cannot be meaningfully analyzed until the runtime. This requires a buffer variable to be created, which is an objective of copying actions or calculations of the parallel control flow branches. Particularly when the buffer variable is a multi-component variable, for example a vector, stack usage increases and the runtime is lengthened owing to the copying.

### SUMMARY

In an exemplary embodiment, the present invention provides a method for generating source code from one or more blocks of a block diagram that comprises at least two blocks and at least one signal link between the at least two blocks. The method includes: transforming, by a computing device, the block diagram into an intermediate representation; successively optimizing, by the computing device, the intermediate representation; and translating, by the computing device, the optimized intermediate representation into source code. Transforming the block diagram into the intermediate representation comprises transforming a block. Transforming the block comprises creating a reference to a block output variable. Creating the reference to the block output comprises: detecting at least two parallel control flow branches which read or write a variable; identifying an operation that accesses the variable; checking whether a cost criterion is satisfied; and reproducing the operation in the at least two parallel control flow branches based on the cost criterion being satisfied. Reproducing the operation comprises shifting the operation from an original position to positions where the variable is read or written.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary embodiment of a computer system;

FIG. 2 is a schematic illustration of software components present in a computer system;

FIG. 3 is a schematic flowchart of an embodiment of a method according to the invention for generating source code; and

FIG. 4 shows a block diagram comprising parallel control flow branches.

### DETAILED DESCRIPTION

Exemplary embodiments of the present invention allow source code to be generated with lower stack usage relative to conventional techniques.

Exemplary embodiments of the present invention include a method for generating source code, a computer program product, and a computer system.

In an exemplary embodiment, the present invention provides a method for generating source code from one or more blocks of a block diagram that comprises at least two blocks and at least one signal link between the blocks. Generating source code comprises transforming the block diagram into an intermediate representation, successively optimizing the intermediate representation, and translating the optimized intermediate representation into source code, wherein transforming a block comprises creating a reference to a block output variable. According to the invention, at least two parallel control flow branches which read or write a variable are detected, an operation that accesses the variable is identified, a check is performed to determine whether a cost criterion is satisfied, and the operation is reproduced in the at least two parallel control flow branches when the cost criterion is satisfied, wherein reproducing the operation comprises shifting the operation from the original position to the positions where the variable is read or written or where the variable is accessed in a read or write manner. Because reproducing the operation comprises shifting the operation, the operation thus does not remain at the original position.

Data or signals can be transmitted via a signal link; in this case, a first block outputs a value or, depending on the definition, a plurality of related values, and a second block receives it/them and takes it/them into account when determining one or more related readout values of the second block. Signals may be scalar variables and/or structured data types such as arrays; for example, a structure variable results from a bus signal in the generated code. If a block comprises the access to a multi-component variable, cutting down these variables can allow for a considerable reduction in storage space and execution time, for example since instructions for copying the individual components or elements of the variables are not generated in the code and therefore need not be executed during the runtime either. The multi-component variable may be a vector comprising a multiplicity of variables of the same data type, a matrix comprising a multiplicity of vectors, a structure comprising a multiplicity of variables of any data type, or a vector or matrix of structures.

A principle of the present application is deciding whether to multiply an operation in the control flow branches concerned during code generation on the basis of a cost measure or simple criteria. Doing so allows a buffer variable to be eliminated or at least replaced with a local variable. Variables are placed on the stack at the start of their scope and take up memory area in proportion to their size; for example, the size for a vector is derived from the dimension and storage requirements of an individual element. After the end of the scope or lifetime of the variables, the corresponding memory area is freed up again. As a result, a local variable results in a lower maximum stack usage of the surrounding program unit owing to the shorter lifetime. If the shift allows for further optimizations which, in particular, can lead to buffer variables being omitted, both the maximum and the typical stack usage of the surrounding program unit can be reduced.

Advantageously, a method according to the invention identifies buffer variables for which a backward propagation and/or a forward propagation can be performed, wherein, in a backward propagation, the variable is an input variable of the operation and reproducing the operation comprises an insertion in the source code upstream of the original operation, or reproducing the operation comprises a shift in the source code upstream of the original position, and wherein, in a forward propagation, the variable is an output variable of the operation and reproducing the operation comprises an insertion in the source code downstream of the original operation, or reproducing the operation comprises a shift in the source code downstream of the original position. On the basis of the relative position of the original operation and the adjacent reading or writing accesses to the variable accessed in the operation, it is clear whether a backward propagation or a forward propagation can be considered.

Preferably, the cost criterion is satisfied without any further verification when the operation is a function call having fewer parameters than a predetermined threshold value and either a forward propagation is performed, in which at least one control flow branch is independent of the variables, or the variable is a multi-component variable. The predetermined threshold value can be five, for example, and it can additionally be required that the parameters are only variables, constants, addresses, or phasors. Optionally, the function call may comprise assigning a return value. A principle of this embodiment is that no detailed verification has to be carried out in some configurations because a reduction is expected in all cases occurring in practice. The cost criterion is thus satisfied without any further verification, or is deemed satisfied, when the operation is a function call having fewer parameters than a predetermined threshold value and, additionally, one of the following conditions is met:
in the case of a forward propagation, at least one control flow branch is independent of the variables and/or the variable is a multi-component variable,
in the case of a backward propagation, the variable is a multi-component variable.

Preferably, the cost criterion takes into account the increase in code size and a decrease in stack usage and/or a potential decrease in runtime. Since multiplying the operation generally causes an increase in code size, this should only be done when the decrease in stack usage and/or runtime is sufficiently great. It can be provided that a predetermined weighting of the measures for stack usage and/or runtime is applied; the weighting can also be specified by the user.

Particularly preferably, the increase in code size is determined on the basis of the number of parallel control flow branches that access the variable, and/or a measure of the complexity of the operation.

Particularly preferably, the decrease in stack usage and/or a potential decrease in runtime is/are determined on the basis of the number of parallel control flow branches that do not access the variable, and the storage requirements and/or a dimension of the variable. If the variable is a multi-component variable, for example a structure having a multiplicity of components or a vector having a multiplicity of elements, a reduced lifetime or a complete elimination of the variables can allow for significant reductions in stack usage. Since a vector is generally copied via a loop, considerable reductions in runtime can also be achieved when the variable is omitted or at least one variable of a smaller dimension can be used.

In embodiments of the invention, the operation comprises a function call and/or a calculation using elements of a multi-component variable. When the variable is a buffer variable for communication between different blocks that are eliminated or can be omitted in the event of an optimization according to the invention, one or more of the following heuristic cost criteria can preferably be checked:
a. When the operation is a function call or a loop comprising a simple calculation using the individual elements of the multi-component variables, a backward propagation or a forward propagation can be performed if the variable is still accessed only within the parallel control flow branches and the variable is merely copied in at least a predetermined number of control flow branches, in particular at least one control flow branch.
b. When the operation is a function call or a loop comprising a simple calculation using the individual elements of the multi-component variables, a forward propagation can be performed if the variable is not actually accessed in at least a predetermined number of control flow branches, in particular at least one control flow branch.
c. When the operation is a loop comprising a simple calculation using the individual elements of the multi-component variables, a backward propagation or a forward propagation can be performed if the variable is still accessed only in the parallel control flow branches and the dimension of the variable can be reduced by at least a predetermined number of bits or bytes.
d. When the operation is a loop comprising a simple calculation using the individual elements of the multi-component variables, a backward propagation or a forward propagation can be performed if the variable is still accessed only in the parallel control flow branches and, in at least a predetermined number of control flow branches, in particular at least one control flow branch, there is a further loop that can be combined with the reproduced loop.

A “simple calculation” may be understood as a calculation that can be formulated in one row of C code (without any further function calls). The simple calculation can comprise storage in a scalar accumulator variable. In operations that comprise a plurality of variables, the optimization according to the invention can be implemented for the variable that satisfies a cost criterion; in this case, it can also be provided that the variable selected out of a plurality of suitable variables is that for which the cost criterion is satisfied most clearly or for which the greatest possible decrease in stack usage and execution time is expected.

It is expedient if the method for generating source code additionally comprises subsequently applying at least one further optimization to the intermediate representation. Since the operation is arranged in the various control flow branches, previously impossible optimizations, in particular combination with a further loop arranged in said control flow branch, can be applied. This may mean that the code size decreases overall, too.

It is particularly expedient if the cost criterion comprises an assessment of the changes in runtime, stack usage, and/or code size that are caused by the at least one further optimization. Even though a precise determination would be complex, an approximated indication can be determined simply and quickly in many cases.

If block diagrams are defined hierarchically, in which case a block in a higher level may comprise a plurality of blocks of a subordinate level and blocks of a subordinate level are allocated to a block of a higher level, it can be provided that a plurality of hierarchical levels are observed jointly.

The invention further relates to a method for configuring a control device, wherein the control device comprises at least one arithmetic logic unit and preferably at least one sensor and/or at least one actuator in order to record data on a physical process and/or influence said process, the method comprising the steps of:
a. inputting a block diagram,
b. generating a source code using a method according to the invention,
c. compiling the source code for the arithmetic logic unit such that an executable code is generated,
d. transmitting the executable code to the control device, and
c. storing the executable code in a non-volatile memory of the control device and/or executing the executable code by the arithmetic logic unit of the control device.

The invention further relates to a computer program product comprising a computer-readable storage medium having commands embedded therein which, when executed by a processor, cause the processor to be configured to carry out a method according to the invention.

The invention further relates to a computer system comprising a human-machine interface, a non-volatile memory, and a processor, wherein the processor is configured to carry out a method according to the invention.

The invention will now be described in more detail with reference to the drawings, in which like parts are designated by the same reference signs. The illustrated embodiments may be highly schematic, i.e., the distances and the lateral and vertical dimensions are not true to scale and, unless indicated otherwise, do not have any derivable geometric relationships to each other either.

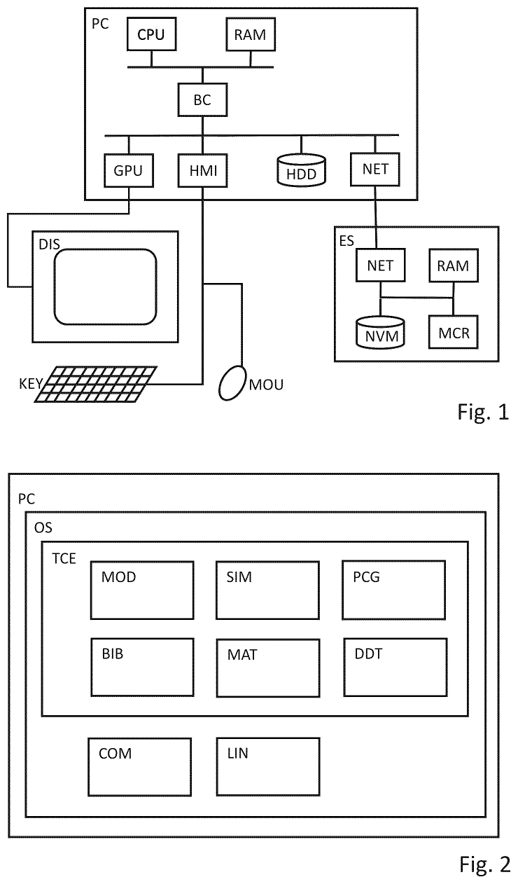

FIG. 1 shows an example configuration of a computer system PC. The computer system has a processor CPU, which may in particular be implemented as a multi-core processor, a main memory RAM, and a bus controller BC. The computer system PC is preferably configured to be manually operated directly by a user, a monitor DIS being connected via a graphics card GPU, and a keyboard KEY and a mouse MOU being connected via a peripheral interface HMI. In principle, the human-machine interface of the computer system PC could also be configured as a touch interface. The computer system further comprises a non-volatile data store HDD, which may in particular be configured as a hard disk and/or solid-state disk, as well as an interface NET, in particular a network interface. A control device ES may be connected via the interface NET. In principle, one or more interfaces of any type, in particular wired interfaces, may be provided on the computer system PC and may each be used for connecting to a control device ES. Expediently, a network interface in accordance with the Ethernet standard may be used; the interface NET may also be wireless, in particular configured as a WLAN interface or in accordance with a standard such as Bluetooth.

The control device ES may be configured as a series control device or as an evaluation board for a target platform. Expediently, it comprises an interface NET for connecting a microcontroller MCR, having a different architecture from the processor of the computer system, and a main memory RAM and a non-volatile memory NVM to the computer system PC. Where the control device ES is present, a processor-in-the-loop simulation of the generated code may preferably take place.

FIG. 2 shows a diagram of the software components that are preferably installed on the computer system PC. These software components use mechanisms of the operating system OS to, for example, access the non-volatile memory HDD or to establish a connection to an external computer via the network interface NET.

A technical computing environment TCE allows models to be created and source code to be generated from the models. In a modeling environment MOD, models of a dynamic system may be created, preferably via a graphical user interface. In particular, these may be block diagrams comprising a plurality of blocks and describing the behavior over time and/or internal states of a dynamic system. At least some of the blocks are linked via signals, i.e., directional links for exchanging data, which may be scalar or composite. Blocks may be atomic, i.e., may, from the perspective of the surrounding blocks, form a unit in which all the input signals have to be applied at the start of a computing step and all the output signals have to be present at the end of a computing step.

If block diagrams are hierarchical, a multiplicity of blocks in a subordinate level may describe the construction of a block in a superordinate level. Hierarchical or composite blocks may comprise a multiplicity of blocks in a subordinate level, even if said blocks are atomic. In particular, composite blocks may be sub-systems; sub-systems may have additional properties, such as implementation in a separate function and/or triggering of the execution of the sub-system via a dedicated signal. Special blocks may be arranged in sub-systems to further specify the properties of the sub-system. The computing environment TCE comprises one or more libraries BIB from which blocks or modules for building a model may be selected. In a script environment MAT, instructions may be input interactively or via a batch file in order to perform calculations or modify the model. The computing environment TCE further comprises a simulation environment SIM that is configured to interpret or execute the block diagram in order to examine the behavior of the system over time. These calculations are preferably carried out using high-precision floating-point numbers on one or more cores of the microprocessor CPU of the computer system.

Preferably, a source code may be generated in a programming language such as C from a created model using a code generator PCG. Additional information on the model, in particular on the block variables, is expediently stored in a definition data pool DDT. Expediently, value ranges and/or scales are allocated to the block variables to assist with the calculation of the model using fixed-point instructions. Desired properties of the source code, for example conformity with a standard such as MISRA, may also be set or stored in the definition data pool DDT. Expediently, each block variable is allocated to a predetermined variable type, and one or more desired properties are set, for example the allowability of optimizations such as merging variables. The code generator PCG preferably analyzes the settings of the definition data pool DDT and takes them into account when generating the source code. The definition data pool DDT may have a tree structure or be stored as a simple file in a memory of the computer system; alternatively, the definition data may be stored in a dedicated database system. The definition data pool may have a program interface and/or import/export functions.

The computer system PC has a compiler COM and a linker LIN, which expediently are configured to generate binary files that can be executed on a control device ES and/or the computer system PC. In principle, a multiplicity of compilers may be provided, in particular cross-compilers for different target platforms in order to assist control devices or evaluation boards ES having different processor architectures.

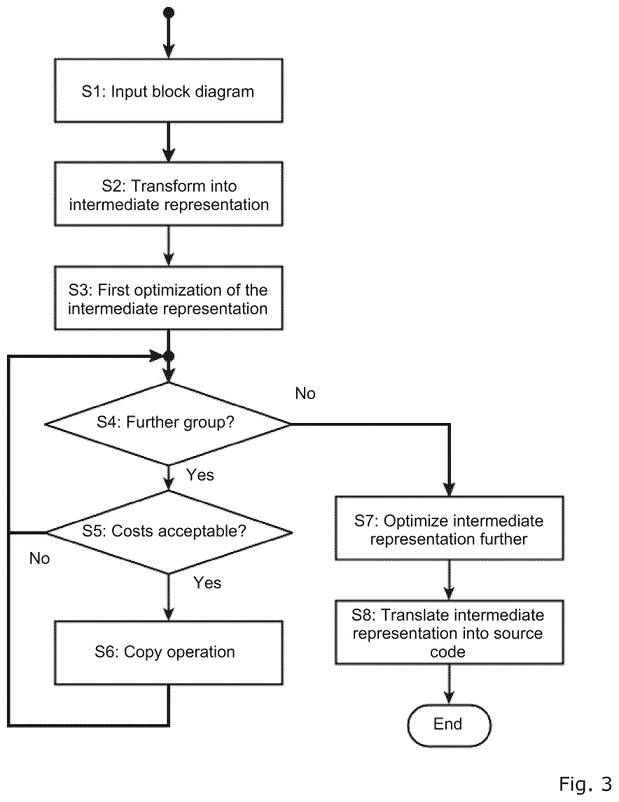

FIG. 3 is a schematic flowchart of an embodiment of a method according to the invention for generating source code. The method may be executed entirely by a processor of an example embodiment of the computer system PC; however, it may also be implemented for execution in a client-server environment having an operator computer and one or more servers linked over a network, in which case computationally intensive steps are in particular carried out on the servers.

In step S1 (Input block diagram), a block diagram is input. The block diagram comprises at least two processing blocks linked by signals and may include a multiplicity of further blocks. Expediently, inputting the block diagram also comprises reading out at least one block property and/or relevant settings for generating the code, for example the data type of a variable, from the definition data pool DDT.

In step S2 (Transform into intermediate representation), the selected model is transformed from one or more blocks of the block diagram into an intermediate representation, which preferably comprises one or more hierarchical graphs. These can in particular be data flow graphs, control flow graphs, or a tree structure. In addition to the block diagram, additional information from a definition data pool DDT is also expediently taken into account when generating the intermediate representation and incorporated therein. This may also include situations in which elements are generated on the basis of information in the definition data pool DDT, or in which properties of elements or relevant settings for generating the code, for example the data type of a variable, are extracted from the definition data pool DDT.

In step S3 (First optimization of the intermediate representation), the hierarchical graphs of the intermediate representation are optimized in order to reduce the number of variables required and/or the memory usage and/or the number of operations or processor instructions and/or the execution time of the source code. This optimization may comprise a plurality of intermediate steps in which further intermediate representations are generated between the model/block diagram and source code/program text. In particular, in each intermediate step, a set of original hierarchical graphs may be converted into a different set of changed hierarchical graphs, with one or more optimization rules being applied. Various strategies may be applied during the first optimization of the intermediate representation, for example constant folding or eliminating dead code.

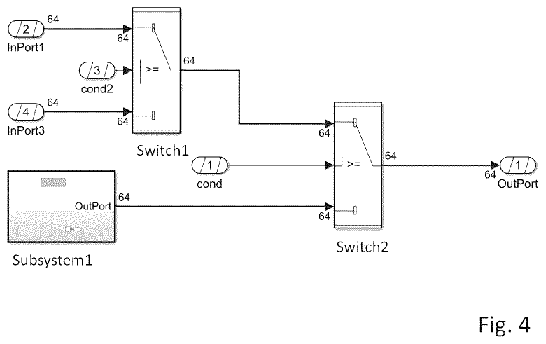

In step S4 (Further group?), it is checked whether there are further groups of operations comprising parallel control flow branches in which a reproduction and shift of an operation may be considered. In this case, the variable may be an input variable of the operation, and a backward propagation can be carried out, in which case the operation is reproduced and is inserted upstream of the original operation in the source code in the parallel control flow branches. Alternatively, the variable may be an output variable of the operation, in which case the operation is reproduced and is inserted into the source code in at least one of a plurality of parallel control flow branches. The description of FIG. 4 and the listings further below show and explain example groups of operations for which an optimization according to the invention can be carried out.

If there is still a group of operations that is suitable for optimization, step S5 follows; otherwise, the execution continues with step S7 in order to perform a further optimization on the intermediate representation.

In step S5 (Costs acceptable?), it is checked whether reproducing the operation satisfies a cost criterion. The cost criterion may be different for backward propagations and forward propagations. Generally, the potential advantages of reproducing the operation, namely a potential reduction in runtime and lower stack usage, have to be weighed against the potential drawback, namely an increase in code size (which may also lead to poorer legibility).

The increase in code size is dependent on the number of parallel control flow branches that access the (common) variable, and the complexity of the operation, for example the number of sub-calculations. A potential reduction in runtime and a reduction in stack usage are dependent on the size and type of the variable. For multi-component variables, in particular a vector, the copying action is more complex because the individual elements are copied; in particular, a for-loop has to be run across the dimension of the vector. In the case of a forward propagation, a potential reduction in runtime and a reduction in stack usage are also dependent on whether there are parallel control flow branches that do not access the variable (meaning that the operation does not actually have to be carried out for these branches). Shifting the operation can also allow for the following optimizations of the intermediate representation, which may lead to a further reduction in runtime and stack usage but also to a reduction in code size. Even if no subsequent optimizations were possible, reproducing the operation would still lead to a reduction in stack usage owing to the reduced scope of the intermediate variables.

In principle, using two weights W1 and W2, a calculation in the form “code size increase<W1*reduction in stack usage+W2*reduction in execution period” can be carried out. If the target platform is known, potential improvements in terms of reduced runtime and lower stack usage, as well as potential added costs in the form of increased code size, can be looked at in detail.

However, since it would be time-consuming to precisely predict the effects of reproducing the operation, it is expedient to make an assessment on the basis of a heuristic cost criterion.

In particular, the following cost criteria can be used for an assessment:

When the operation comprises a loop and perhaps an accumulator variable, reproducing the operation is expedient when one of the following conditions is satisfied:
1. At least one control flow branch of the parallel control flow branches comprises a further loop that can be combined with the loop of the (shifted) operation.
2. For a forward propagation, there is at least one control flow branch that does not access the variable; alternatively, a larger number of control flow branches that do not access the variable can also be required.
3. The variable is a multi-component variable, and shifting the loop allows an input or output variable of a smaller dimension to be used; in this case, a minimum decrease in the dimension can be required.

When the operation comprises a function call, in particular consists solely of the function call, reproducing the operation is expedient when one of the following conditions is satisfied:
1. In at least one control flow branch of the parallel control flow branches, the intermediate variable can be eliminated or omitted.
2. For a forward propagation, there is at least one control flow branch that does not access the variable; alternatively, a larger number of control flow branches that do not access the variable can also be required.

If the cost criterion is satisfied, meaning that the costs are deemed acceptable, then step S6 follows; otherwise, the execution continues with step S4 in order to verify whether further optimizable groups of operations are present.

In the event of a positive cost-benefit assessment, in step S6 (Copy operation) the operation is copied into the different parallel control flow branches in order to allow for reduced stack usage and potentially further optimizations. Reproducing the operation comprises removing the operation at the original position, i.e., the operation is shifted into the parallel control flow branches. The execution then continues with step S4 in order to process any further suitable groups of operations.

In step S7 (Optimize intermediate representation further), the hierarchical graphs are further optimized in order to reduce the number of variables required and/or the memory usage, for example stack occupation, and/or the number of operations or processor instructions and/or the execution time of the source code. This optimization may comprise a multiplicity of intermediate steps in which further intermediate representations are generated between the model/block diagram and source code/program text. In particular, in each intermediate step, a set of original hierarchical graphs may be converted into a different set of changed hierarchical graphs, with one or more optimization rules being applied. During the further optimization, different optimization strategies can be applied.

In step S8 (Translate intermediate representation into source code), the optimized intermediate representation or the optimized hierarchical graphs resulting from the entirety of the intermediate steps carried out are translated into source code of a textual programming language, in particular C code. In this step too, a further optimization may be performed, in particular such that the generated instructions represent a sub-set of the instructions included in principle by the language and/or the generated control structures represent a sub-set of the control structures included in principle by the language. This makes it possible to satisfy precisely defined rules. Alternatively or additionally, additional information, for example a reference between program rows and a block of the block diagram, may be generated and incorporated into the source code in particular in the form of comments in order to improve the legibility of the source code and/or simplify debugging.

During or after code generation, information on the current block diagram or results of the code generation, for example warnings, may be stored in the definition data pool. This information may be used, for example, to influence compiling of the generated source code, or to provide meta information for other tools, for example calibration information in ASAP2 format or information for generating an intermediate layer in accordance with the AUTOSAR standard. In alternative embodiments of the invention, code in a hardware description language or a configuration of a programmable hardware component may be generated from the block diagram.

Example embodiments of the invention will be explained below.

FIG. 4 shows a block diagram comprising parallel control flow branches. A multi-component input signal is received via a first input port InPort1 and supplied to a switching block Switch1; in the example shown, the multi-component input signal is a vector comprising 64 elements. A further multi-component input signal—a vector of the same size—is received via a second input port InPort3 and supplied to the switching block Switch1. A scalar input signal is received via a third input port cond2 and supplied to a selection input of the switching block Switch1. Depending on the value applied to the selection input, the switching block relays one or the other of the two multi-component input signals to a second switching block Switch2.

The block diagram further comprises a hierarchical block or sub-system Subsystem1, which outputs a further multi-component signal, in this case a vector signal comprising 64 elements, which is likewise supplied to the second switching block Switch2. A scalar input signal is received via a fourth input port cond and supplied to a selection input of the second switching block Switch2. Depending on the value applied to the selection input, the second switching block relays the output signal of the first switching block or the output signal of the hierarchical block Subsystem1 to an output port OutPort. Overall, therefore, the output signal of OutPort is dependent on one of the parallel control flow branches in the block diagram, and the valid signal can first be determined on the basis of the signal values applied to the selection inputs during the runtime. If the block diagram is a Classic AUTOSAR model, the output port can in particular provide explicit transmitter-receiver communication. This is implemented in the generated code by an RTE_Write function call.

Without any optimization according to the present invention, the source code shown in Listing 1 would be generated from the block diagram.

Listing 1—Function Call with No Optimization:

```
  uint32 Sa3_Switch[64];
  sint16 MyImplicitIRV_int16_2;
  MyImplicitIRV_int16_2 =
Rte_IrvRead_Run_MyImplicitIRV_int16_2( );
  if (Rte_IrvRead_Run_MyImplicitIRV_int16( ) >= 0) {
    sint32 Aux_S32;
    if (MyImplicitIRV_int16_2 >= 0) {
      for (Aux_S32 = 0; Aux_S32 < 64; Aux_S32++){
        Sa3_Switch[Aux_S32] =
Rte_IrvIRead_Run_InVector1( )[Aux_S32];
      }
    }
    else {
      for (Aux_S32 = 0; Aux_S32 < 64; Aux_S32++){
        Sa3_Switch[Aux_S32] =
Rte_IrvIRead_Run_InVector3( )[Aux_S32];
      }
    }
  }
  else {
    Sa4_Subsystem(Sa3_Switch);
  }
Rte_Write_MySenderReceiverPort_MyVector64_DataElement(Sa3_Swit
ch);
```

For the switching block or blocks, a block output variable Sa3_Switch that has high storage requirements on the stack is applied. In addition, depending on the signals applied to the selection inputs, different copying actions have to be performed (in the for-loops), which lengthen the required runtime of the program.

Listing 2 shows a source code optimized in accordance with a method according to the invention. In this case, a backward propagation is performed, in which the multi-component variable is an input variable of the operation, i.e. of the RTE function call, and reproducing the operation comprises an insertion in the source code upstream of the original operation, i.e., the function call is reproduced in the parallel control flow branches upstream of the original function call. Since the operation has been reproduced in all parallel control flow branches, it does not remain at the original position; reproducing the operation thus comprises a shift to earlier rows of the source code.

Therefore, the optimization multiplies the RTE_Write call, as a result of which the Sa3_Switch variable is no longer needed and the copying actions can be omitted. It is only in the control flow branch having Subsystem1 that a buffer variable is needed, although this may have a narrower scope compared with Listing 1. Thus, both the stack usage and the required execution time are reduced in two of the control flow branches.

Listing 2—Function Call with Backward Propagation:

```
    sint16 MyImplicitIRV_int16_2;
    /* TargetLink Inport: Subsystem/SWC/Run/cond2 */
    MyImplicitIRV_int16_2 =
  Rte_IrvRead_Run_MyImplicitIRV_int16_2( );
    if (Rte_IrvRead_Run_MyImplicitIRV_int16( ) >= 0) {
  if (MyImplicitIRV_int16_2 >= 0) {
  Rte_Write_MySenderReceiverPort_MyVector64_DataElement(Rte
  _IrvIRead_Run_InVector1( ));
      }
      else {
  Rte_Write_MySenderReceiverPort_MyVector64_DataElement(Rte
  _IrvIRead_Run_InVector3( ));
      }
    }
    else {
      uint32 Sa3_Switch[64];
      Sa4_Subsystem(Sa3_Switch);
Rte_Write_MySenderReceiverPort_MyVector64_DataElement(Sa3_Swit
ch);
}
```

Because reproducing a function call causes only a small increase in code size, a more precise cost assessment can be omitted at least for the backward propagation of a function call if the function call comprises only a few parameters (fewer than a predetermined threshold value such as five) and does not comprise any further calculations. If this is satisfied, in particular in the case of a setter access function, the cost criterion can be deemed to be always satisfied in the backward propagation of the function call.

A backward propagation can, however, also be expedient for other operations, for example for calculation in a loop. In this case, it is expedient to assess the cost on the basis of a C code-like intermediate representation. For this reason, only the source code is shown below without an associated block diagram. The source code shown in Listing 3 has been generated from a block diagram in which vector signals are supplied to a switching block from which a case distinction is generated via a “case” statement. The output vector signals are combined via a merge block, and the individual elements are added together. In the source code, a loop comprising an accumulator variable Aux_S16 is generated.

Listing 3—Loop Calculation with No Optimization:

```
  void myStepFcn(void) {
    Int32 Aux_S32;
    Int16 Aux_S16;
    Int16 Sa1_Merge[64];
    switch (Sa1_InPort) {
      case 1: {
        Sa5_Subsystem(Sa1_Merge);
        break;
      }
      case 2: {
        for (Aux_S32 = 0; Aux_S32 < 64; Aux_S32++) {
          Sa1_Merge[Aux_S32] = Sa1_InPort1[Aux_S32];
        }
        break;
      }
      default: {
        static Int16 X_Sa4_Unit_Delay[64] = { 0 };
        for (Aux_S32 = 0; Aux_S32 < 64; Aux_S32++) {
          Sa1_Merge[Aux_S32] =
  X_Sa4_Unit_Delay[Aux_S32];
          if (Sa1_InPort2[Aux_S32] >= 0) {
            X_Sa4_Unit_Delay[Aux_S32] =
  Sa1_InPort2[Aux_S32];
          }
          else {
            X_Sa4_Unit_Delay[Aux_S32] =
  Sa1_Merge[Aux_S32];
          }
        }
        break;
      }
    }
    Aux_S16 = 0;
    for (Aux_S32 = 0; Aux_S32 < 64; Aux_S32++) {
      Aux_S16 = (Int16) (((UInt16) Aux_S16) + ((UInt16)
  Sa1_Merge[Aux_S32]));
    }
    Sa1_OutPort1 = Aux_S16;
}
```

The loop comprising the accumulator variable Aux_S16 comprises an access to the individual elements of the array Sa1_Merge, so this array has to be present for the entire scope of the encompassing function and also leads to considerable stack usage owing to the 64 elements. By reproducing both the loop comprising the accumulator variables and the prior initialization of the accumulator variables, reductions can be obtained in a plurality of control flow branches, namely for Case 2 and the Default Case. This is shown in Listing 4.

Listing 4—Loop Calculation with Backward Propagation:

```
  void myStepFcn(void) {
    Int32 Aux_S32;
    Int16 Aux_S16;
    Aux_S16 = 0;
    switch (Sa1_InPort) {
      case 1: {
        Int16 Sa1_Merge[64];
        Sa5_Subsystem(Sa1_Merge);
        for (Aux_S32 = 0; Aux_S32 < 64; Aux_S32++) {
            Aux_S16 = (Int16) (((UInt16) Aux_S16) +
  ((UInt16) Sa1_Merge[Aux_S32]));
        }
        break;
      }
      case 2: {
        for (Aux_S32 = 0; Aux_S32 < 64; Aux_S32++) {
            Aux_S16 = (Int16) (((UInt16) Aux_S16) +
  ((UInt16) Sa1_InPort1[Aux_S32]));
        }
        break;
      }
      default: {
        static Int16 X_Sa4_Unit_Delay[64] = { 0 };
        Int16 Aux;
        for (Aux_S32 = 0; Aux_S32 < 64; Aux_S32++) {
          Aux = X_Sa4_Unit_Delay[Aux_S32];
          if (Sa1_InPort2[Aux_S32] >= 0) {
            X_Sa4_Unit_Delay[Aux_S32] =
  Sa1_InPort2[Aux_S32];
          }
          else {
            X_Sa4_Unit_Delay[Aux_S32] = Aux;
          }
            Aux_S16 = (Int16) (((UInt16) Aux_S16) +
  ((UInt16) Aux));
        }
        break;
      }
    }
    Sa1_OutPort1 = Aux_S16;
}
```

The array variable Sa1_Merge is only required for the control flow branch Case 1 and can thus be given a reduced scope having accordingly reduced stack usage. The array variable can be omitted entirely from the control flow branch Case 2. In the Default Case control flow branch, the array variable can be replaced with a scalar auxiliary variable since all the accesses occur within the same loop and only one element is accessed in each iteration. Altogether, therefore, both runtime and stack usage are reduced for two control flow branches.

If a plurality of parallel control flow branches receive a variable and the variable is an output variable of an operation, reproducing the operation can also lead to reduced stack usage. This can also be referred to as a forward propagation, in which case reproducing the operation comprises an insertion in the source code downstream of the original operation. The operation is thus shifted into all the parallel control flow branches that receive the variable. When one or more of the parallel control flow branches are independent of the variables and therefore do not use them as an input variable, describing the variables can also be omitted from these control flow branches, i.e., the operation and the variable can be omitted entirely from the independent control flow branches. The stack usage and execution time are reduced in these control flow branches without the code size being increased.

Listing 5 shows example code that is suitable for optimization via a forward propagation; this example code has been generated from a block diagram that comprises a switch case block and action sub-systems connected thereto. In principle, other models such as a switching block having a plurality of inputs can also be optimized by a forward propagation. In the example code shown, the various control flow branches or cases have partly different input variables. The first case has a bus input variable or a structure that originates from a function call. The second case has a scalar input variable containing a pre-calculated sum of the elements of a vector. The Default Case receives both input variables.

### Listing 5—Loop Calculation as Input Variable:

```
void myStepFcn(void){
  struct SmallStruct_tag Sa2_Bus_Outport_a;
  Int32 Aux_S32;
  Int16 Aux_S16;
  Aux_S16 = 0;
  for (Aux_S32 = 0; Aux_S32 < 64; Aux_S32++) {
    Aux_S16 = (Int16) (((UInt16) Aux_S16) + ((UInt16)
Sa1_InPort1[Aux_S32]));
  }
  Sa2_Subsystem(&Sa2_Bus_Outport_a);
  switch (Sa1_InPort) {
    case 1: {
      Sa1_OutPort1 = Sa2_Bus_Outport_a.c0;
      break;
    }
    case 2: {
      Sa1_OutPort1 = Aux_S16;
      break;
    }
    default: {
      Sa1_OutPort1 = (Int16) (Sa2_Bus_Outport_a.c1 +
Aux_S16);
      break;
    }
  }
}
```

Listing 6 shows the example code after being optimized via a forward propagation.

Listing 6—Loop Calculation as Input Variable with Optimization:

```
  switch (Sa1_InPort) {
    case 1: {
      struct SmallStruct_tag Sa2_Bus_Outport_a;
      Sa2_Subsystem (&Sa2_Bus_Outport_a);
      Sa1_OutPort1 = Sa2_Bus_Outport_a.c0;
      break;
    }
    case 2: {
      Int16 Aux_S16;
      Aux_S16 = 0;
      for (Aux_S32 = 0; Aux_S32 < 64; Aux_S32++) {
        Aux_S16 = (Int16) (((UInt16) Aux_S16) +
((UInt16) Sa1_InPort1[Aux_S32]));
      }
      Sa1_OutPort1 = Aux_S16;
      break;
    }
    default: {
      struct SmallStruct_tag Sa2_Bus_Outport_a;
      Int16 Aux_S16;
      Aux_S16 = 0;
      for (Aux_S32 = 0; Aux_S32 < 64; Aux_S32++) {
        Aux_S16 = (Int16) (((UInt16) Aux_S16) +
((UInt16) Sa1_InPort1[Aux_S32]));
      }
      Sa2_Subsystem(&Sa2_Bus_Outport_a);
      Sa1_OutPort1 = (Int16) (Sa2_Bus_Outport_a.c1 +
Aux_S16);
      break;
  }
```

The operation of a loop comprising calculation of the sum using the individual vector elements was reproduced and shifted into the control flow branches of Case 2 and the Default Case. In Case 1, the loop and the auxiliary variable can be omitted entirely for the sum since the result is not used in this control flow branch. There are no reductions for the Default Case since both variables are used in calculations.

Reproducing and shifting operations allows stack usage and possibly also execution time to be reduced. Checking a cost criterion allows for weighing against an increased code size. This can lead to considerable improvements in memory usage and execution speed, particularly when carried out in conjunction with subsequent optimizations.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B. or the entire list of elements A, B and C.

1. A method for generating source code from one or more blocks of a block diagram that comprises at least two blocks and at least one signal link between the at least two blocks, the method comprising:
transforming, by a computing device, the block diagram into an intermediate representation;
successively optimizing, by the computing device, the intermediate representation; and
translating, by the computing device, the optimized intermediate representation into source code;
wherein transforming the block diagram into the intermediate representation comprises transforming a block, wherein transforming the block comprises creating a reference to a block output variable, and wherein creating the reference to the block output comprises:
detecting at least two parallel control flow branches which read or write a variable;
identifying an operation that accesses the variable;
checking whether a cost criterion is satisfied; and
reproducing the operation in the at least two parallel control flow branches based on the cost criterion being satisfied, wherein reproducing the operation comprises shifting the operation from an original position to positions where the variable is read or written.

2. The method according to claim 1, wherein a backward propagation and/or a forward propagation is/are performed, wherein, in the backward propagation, the variable is an input variable of the operation and reproducing the operation comprises a shift in the source code upstream of the original position, and wherein, in the forward propagation, the variable is an output variable of the operation and reproducing the operation comprises a shift in the source code downstream of the original position.

3. The method according to claim 2, wherein the cost criterion is satisfied without any further verification based on the operation being a function call having fewer parameters than a predetermined threshold value and, additionally, one of the following conditions is met:
in the case of the forward propagation, at least one control flow branch is independent of the variables and/or the variable is a multi-component variable, or
in the case of the backward propagation, the variable is a multi-component variable.

4. The method according to claim 1, wherein the cost criterion takes into account:
the increase in code size; and
a decrease in stack usage and/or a potential decrease in runtime.

5. The method according to claim 4, wherein the increase in code size is determined on the basis of the number of parallel control flow branches that access the variable, and/or a measure of the complexity of the operation.

6. The method according to claim 4, wherein the decrease in stack usage and/or the potential decrease in runtime is determined on the basis of:
the number of parallel control flow branches that do not access the variable, and
the storage requirements and/or a dimension of the variable.

7. The method according to claim 1, wherein the operation comprises a function call and/or a calculation using elements of a multi-component variable.

8. The method according to claim 1, further comprising:
applying at least one further optimization to the intermediate representation.

9. The method according to claim 8, wherein the cost criterion comprises an assessment of the changes in runtime, stack usage, and/or code size that are caused by the at least one further optimization.

10. A method for configuring a control device comprising at least one arithmetic logic unit, the method comprising:
inputting a block diagram;
generating source code from one or more blocks of the block diagram that comprises at least two blocks and at least one signal link between the at least two blocks;
compiling the source code for the at least one arithmetic logic unit such that executable code is generated;
transmitting the executable code to the control device; and
storing the executable code in a non-volatile memory of the control device and/or executing the executable code by the at least one arithmetic logic unit of the control device;
wherein generating the source code comprises:
transforming the block diagram into an intermediate representation;
successively optimizing the intermediate representation; and
translating the optimized intermediate representation into source code;
wherein transforming the block diagram into the intermediate representation comprises transforming a block, wherein transforming the block comprises creating a reference to a block output variable, and wherein creating the reference to the block output comprises:
detecting at least two parallel control flow branches which read or write a variable;
identifying an operation that accesses the variable;
checking whether a cost criterion is satisfied; and
reproducing the operation in the at least two parallel control flow branches based on the cost criterion being satisfied, wherein reproducing the operation comprises shifting the operation from an original position to positions where the variable is read or written.

11. A non-transitory computer-readable medium having processor-executable instructions stored thereon for generating source code from one or more blocks of a block diagram that comprises at least two blocks and at least one signal link between the at least two blocks, wherein the processor-executable instructions, when executed, facilitate performance of the following:
transforming the block diagram into an intermediate representation;
successively optimizing the intermediate representation; and
translating the optimized intermediate representation into source code;
wherein transforming the block diagram into the intermediate representation comprises transforming a block, wherein transforming the block comprises creating a reference to a block output variable, and wherein creating the reference to the block output comprises:
detecting at least two parallel control flow branches which read or write a variable;
identifying an operation that accesses the variable;
checking whether a cost criterion is satisfied; and
reproducing the operation in the at least two parallel control flow branches based on the cost criterion being satisfied, wherein reproducing the operation comprises shifting the operation from an original position to positions where the variable is read or written.
